(19) United States
(12) Patent Application Publication
(10) Pub. No.: US 2017/0092163 A1
(43) Pub. Date: Mar. 30, 2017

(54) PORTABLE SIGN, SIGN ASSEMBLY, KIT AND METHOD

(71) Applicant: Markers, Inc., Avon Lake, OH (US)

(72) Inventor: Dale J. Hlavin, Westlake, OH (US)

(73) Assignee: Markers, Inc.

(21) Appl. No.: 15/277,605

(22) Filed: Sep. 27, 2016

Related U.S. Application Data
(60) Provisional application No. 62/235,529, filed on Sep. 30, 2015.

(51) Int. Cl. G09F 7/18; G09F 15/00

(52) U.S. Cl. CPC G09F 7/18; G09F 15/0037; G09F 15/0056; G09F 2007/1804

(57) ABSTRACT

Various examples of a portable sign, a sign assembly, a kit, and methods for making the portable sign and sign assembly are disclosed herein. In one example of the present invention a portable sign includes a central portion, a first end portion extending from the central portion at a first angle relative to the central portion, and a second end portion extending from the central portion at a second angle relative to the central portion. The portable sign is a unitary structure and each of the central portion, first end portion and second end portion includes a front wall, a rear wall and an inner wall disposed between the front wall and the rear wall.

### RELATED APPLICATION

This application claims the benefit of U.S. Provisional Application No. 62/235,529, entitled “Portable Sign, Sign Assembly, Kit and Method” filed Sep. 30, 2015, the entire content of which is incorporated by reference herein.

### FIELD OF THE INVENTION

The present invention relates generally to portable signs, sign assemblies, kits and a method of making the signs and sign assemblies.

### BACKGROUND

Signs are widely used both indoors and outdoors to attract attention. Signs may display lettering, graphics, numbers, colors, logos etc. to communicate warnings, identify company names, schools, club affiliations, sponsorships, advertising, etc. Signs need to be affixed to something and can be difficult and cumbersome to assemble and disassemble and may require retrofitting. Traditional signs take substantial time to design and assemble when something quick and inexpensive is needed for a variety of applications and environments.

### SUMMARY

In one example of the present invention a portable sign for a pole, and includes a central portion, a first end portion extending from the central portion at a first angle relative to the central portion, and a second end portion extending from the central portion at a second angle relative to the central portion. The portable sign is a unitary structure and each of the central portion, first end portion and second end portion includes a front wall, a rear wall and an inner wall disposed between the front wall and the rear wall.

In another example a sign assembly includes a portable sign and a pole for mounting the portable sign. The portable sign is constructed of a first wall, a second wall and an inner wall disposed between the first wall and the second wall. The portable sign includes a central portion oriented at a first angle relative to a first end portion and the central portion is oriented at a second angle relative to the second end portion. The pole extends through a first opening in the first end portion of the portable sign and also through a second opening in a second end portion of the sign.

In another example a sign assembly kit includes a portable sign and a pole. The portable sign includes a first wall, a second wall and an inner wall disposed between the first wall and the second wall.

In yet another example of the present invention, a method for making a portable sign assembly includes folding a portable sign having a first wall, a second wall and inner wall disposed between the first wall and second wall; forming an opening of a first end portion and a second opening of a second end portion of portable sign; and mounting the portable sign onto a pole such that the pole extends through the openings of the first end portion and second end portion of sign.

### BRIEF DESCRIPTION OF THE DRAWINGS

The various embodiments of the present invention can be understood with reference to the following drawings. The components in the drawings are not necessarily to scale. Also, in the drawings, like reference numerals designate corresponding parts throughout the several views.

FIG. 1 is a perspective view of a sign system, according to an example embodiment of the present invention;

FIG. 2 is a perspective view of a portable sign of the sign assembly shown in FIG. 1, according to an example of the present invention;

FIG. 3 is a side view of the portable sign of FIGS. 1 and 2, according to an example of the present invention;

FIG. 4 is a perspective view of the portable sign of FIGS. 1-3 in an extended, planar position, according to an example of the present invention;

FIG. 5 is a top view of the portable sign shown in FIGS. 1-3, according to an example of the present invention;

FIG. 6 is a bottom view of the portable sign shown in FIGS. 1-3, according to an example of the present invention;

FIG. 7 is a perspective view of another example of a portable sign, according to an example of the present invention;

FIG. 8 is a partial perspective view of the portable sign of FIG. 1 modified to include a slit cut, according to an example of the present invention;

FIG. 9 is a partial perspective view of the portable sign of FIG. 1 modified to include a perforated slit cut, according to an example of the present invention;

FIG. 10 is a partial perspective view of the portable sign of FIG. 1 modified to include a pressure score, according to an example of the present invention;

FIG. 11 is a side view of the sign system of FIG. 1 further including protrusion, according to an example embodiment of the present invention; and

FIG. 12 is a perspective view of an alternative sign system having at least two poles, according to an example embodiment of the present invention.

### DETAILED DESCRIPTION

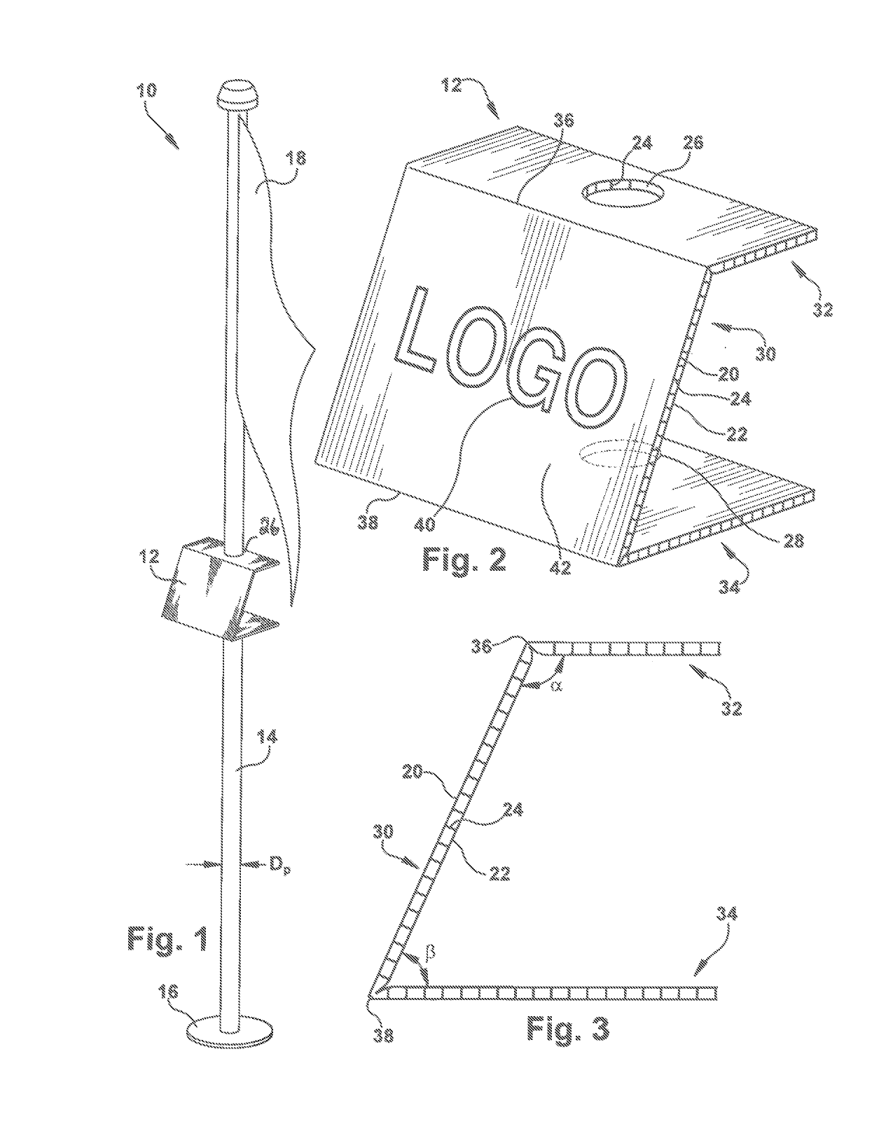

Various examples of a portable sign, a sign assembly, a kit, and methods for making the portable sign and sign assembly are disclosed herein. The portable sign is easy to assemble and can be reused. FIG. 1 illustrates a perspective view of a sign assembly 10 which includes a portable sign 12 and pole 14, and optionally, a pole stand 16 and flag 18 provided at opposite ends of the pole 14. Although pole 14 is shown as round, it can have any one of a variety of geometric shapes, including but not limited to, oval, rectangular, square, triangular, etc. Sign assembly 10 is illustrated as a flagpole-type assembly that can be used, for example on a golf course, although it is to be understood herein that a flagpole-type assembly 10 illustrated in FIG. 1 is only one of a myriad of possible examples of a portable sign assembly 10, and a golf course is only one of many possible venues of use for sign assembly 10. Alternative sign assemblies can include more than one pole 14 (see FIG. 10) and more than one portable sign 12, for example for larger sign systems or for increased stability, depending upon the environment. Sign assembly 10, in accordance with several examples of the present invention can be used for many application uses, including but not limited to, inside buildings, for example stores signs, and outside in many environments such as lawns, parking lots, and construction sites. Sign assembly 10 provides a quick, easy and inexpensive way to convey messages in a visible way and can accommodate a wide range and number of poles 14.

FIG. 2 is close-up, perspective view of a portable sign 12 of the sign assembly 10 shown in FIG. 1. Portable sign 12 is a unitary structure that has a central portion or “face portion” 30 disposed between a first end portion or “top portion” 32, and a second end or “bottom portion” 34. Top portion 32 and bottom portion 34 are bent or angled relative to central portion 30 along folds 36 and 38, respectively. Each of the central portion 30, the top portion 32 and the bottom portion 34, includes a first wall or “front wall” 20, a second wall or “rear wall” 22, and a plurality of interior walls 24 that extend from front wall 20 to rear wall 22. Front wall 20 extends substantially parallel to rear wall 22. Front wall 20, rear wall 22 and interiors walls 24 can be made of the same or different materials. Suitable materials include, but are not limited to, paper or cardboard, polymer, for example, thermoplastic or thermoset polymer. Example polymers include, but are not limited to, polyethylene, polypropylene, styrene, nylon, acrylic, polycarbonate, polyester, acrylonitrile butadiene styrene (ABS), polyvinylchloride (PVC), and blends thereof. A suitable portable sign 12 can be made of a corrugated twin-walled sheet made of polypropylene is commonly known as Coroplast®, and is manufactured by Coroplast of Vanceburg, Ky.

Portable sign 12 has an opening 26 in top portion 32 and an opening 28 in bottom portion for securing portable sign onto pole 14. The shape of openings 26 and 28 generally correspond to the shape of pole 14 and can be one of a variety of geometric shapes, including but not limited to, round, oval, rectangular, square, triangular, etc. In one example, the openings 26, 28 are aligned with one another. Optionally, portable sign 12 can include insignia 40, for example, design, logo, lettering, emblem, mark, etc., on central portion 30 or a display surface 42 of front wall 20. Such insignia may be applied to or written directly on portable sign 12 or may be contained on a separate decal, for example vinyl cut insignia, which is adhered to portable sign 12. The portable sign 12 can be reused and new logo or message can be applied, for example, by adhering a new decal to cover any previous message or insignia on the display surface 42.

FIG. 3 illustrates a side view of portable sign 12 showing the relative positions of central portion 30, top portion 32 and bottom portion 34. In the example as shown in FIGS. 1-3, the top portion 32 and the bottom portion 34 are bent generally towards one another along folds 36 and 38. Central portion 30 and top portion 32 are oriented at an angle α relative to one another. The central portion 30 and bottom portion 34 are oriented at an angle β relative to one another. The folds 36 and 38 creates thinned sections of material between front wall 20 and rear wall 22 that provide a “living hinge” which allows the portable sign 12 to bend to create angles α and β and accommodate any pole 14. Several polymers, for example, polyethylene and polypropylene have excellent fatigue resistance and can maintain connection with pole 14.

The angles α and β can vary and may depend at least in part by the desired position of central portion 30 and the top and bottom end portions 32, 34. As shown in the FIGS. 1-3 the angles α and β are different from one another and angle β is less than angle α to produce a central portion 30 and display surface 42 that is slanted or directed upwards. Top portion 32 and bottom portion 34 are substantially parallel to one another and lie in substantially horizontal planes. The upward slant of central portion 30 allows for easy viewing of any insignia on portable sign 12 when eye level is above portable sign 12. In another example, angle α can be less than angle β such that central portion 30 has a downward slant for easy viewing when eye level is below display surface 42 of portable sign. In an alternative example, angle α and angle β can be substantially equal to one another. Angles α and β can each range from greater than zero degrees to less than 180 degrees, in another example from about 10 degrees to about 170 degrees, and in another example from about 45 degrees to about 135 degrees. The sum of the angles α and β shown in FIGS. 1-3 is about 180 degrees with top portion 32 and bottom portion 34 substantially parallel; however, in other examples the sum of angles α and β can range from about 160 degrees to about 200 degrees. The tension stored within folds 36, 38, when portable sign 12 is mounted on pole 14 creates a “locking mechanism” or frictional engagement that holds the portable sign in place, for example without any fastening devices, and the assembly is “self-locking” with engagement between portable sign 12 and pole 14.

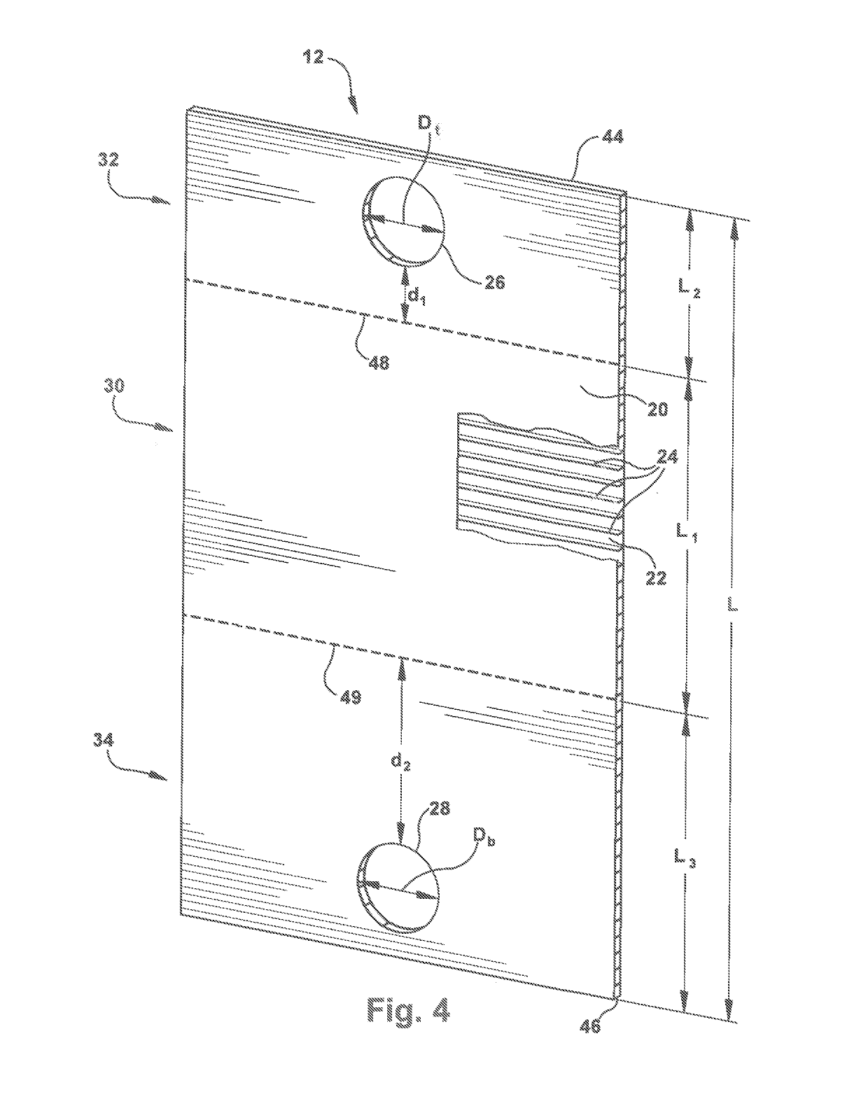

FIG. 4 shows portable sign 12 disposed in an extended and substantially planar position without bends or folds 36 and 38 (FIGS. 2-3). That is, central portion 30, top portion 32, and bottom portion 34 are disposed in a single plane, prior to being bent along bend lines 36 and 38. Optionally, perforations, or “score cuts” 48 and 49 are present on front wall 20 and coincide with the locations of folds 36 and 38 to facilitate easy bending of portable sign 12. Pressure scores and various types of score cuts are possible and described in more detail below. Additionally, pressure scores, slits and perforations can be present on the rear wall 22 rather than, or in addition to, along the front wall 20.

The placement of folds and/or score cuts, if present, relative to the openings 26 and 28 can determine the angle of central portion 30 and display surface 42 relative to top and bottom end portions 32, 34, and also to pole 14 (FIG. 1) once assembled. Distance d₁ is the linear distance between the fold 36 and/or score line 48, if present, and opening 26. Distance d₂ is the distance between fold 38, and score line 49 if present, and opening 28. Once portable sign 12 is mounted on pole 14, the openings 26 and 28 align with one another such that they are coaxial along the length of the pole 14, with portion 30 being parallel to or at an angle relative to pole 14. The relative distances, d₁ and d₂, determine the angle of the central portion 30 relative to pole 14, and determines, at least in part, the angles (i.e. angles α and β) of central portion 30 relative to end portions 32 and 34. As shown in FIG. 4, d₁ is less than d₂ as score line 48 is closer to opening 26 than score line 49 is to opening 28; and thereby presents an angled central portion 30 and displace surface 42 upon assembly.

The overall length L of portable sign 12 is the summation of the lengths L₁ of central portion 30, length L₂ of end portion 32, and length L₃ of end portion 34. Each of the lengths, L₁, L₂, and L₃ can be the same as or different from each other length L₁, L₂, and L₃. In addition, two portions of portable sign 12, having lengths, L₁ and L₃, can be equal in length and also greater or smaller than a third portion having length, L₂, of the portable sign. In one example, the central portion 30 has a length L₁ that is greater than the lengths L₂, L₃ of end portions 32, 34. In another example, central portion 30 has a length L₁ that is the same as the length L₂ of end portion 32 with the lengths L₁, L₃ being greater or less than the length L₃ of end portion 34.

The cut-away view of FIG. 4 front wall 20 of portable sign 12 reveals a plurality of inner walls 24 which run parallel to one another and parallel to fold lines 36 and 38 (see FIG. 2) according to another example embodiment. Folds of portable sign 12 are located on the rear wall 22 between inner walls 24. Likewise, the location of the optional pressure scores and/or cut scores 48, 49 coincide with the location of the folds 36 and 38.

Opening 26 of top portion 32 has a diameter, Dₜ, and opening 28 of bottom portion 34 has a diameter D_{b}. Diameters Dₜ and D_{b} are substantially equal to each other. The diameters Dₜ and D_{b} of openings 26, 28, can be slightly less than the outer diameter Dₚ of pole 14 (see FIG. 1). The flexible and resilient configuration of the portable sign 12 having flexible portions 30, 32, 34 allows deformation of the portable sign to bend or flex near the openings 26, 28 when pole 14 extends through openings 26, 28. In other words, the openings 26, 28 can form a friction fit with the pole 14. The flexibility of portable sign 12 near openings 26, 28, can depend at least in part by the material characteristics or geometry of inner wall 24, for example. For example, the outer diameter of pole 14 can be 1 inch and the diameter of the opening can be 15/16 inch or 31/32 inch or smaller. In another example the diameter Dₜ of the opening 26 in the top portion 32 of the portable sign 12 and the diameter D_{b} of the opening 28 in the bottom portion 34 of the portable sign 12 are within about 95% to about 100% of the outer diameter Dₚ of pole 14, and in another example within about 98% to about 100% of the outer diameter Dₚ of pole 14. It will be understood, however, that the portable sign 12 could be held on the pole 14 with only a friction fit provided by the difference in size between openings 26, 28 and the pole 14, or portable sign 12 could be held on the pole 14 with only the locking mechanism created by the stored tension of the portable sign created by the folds and described above.

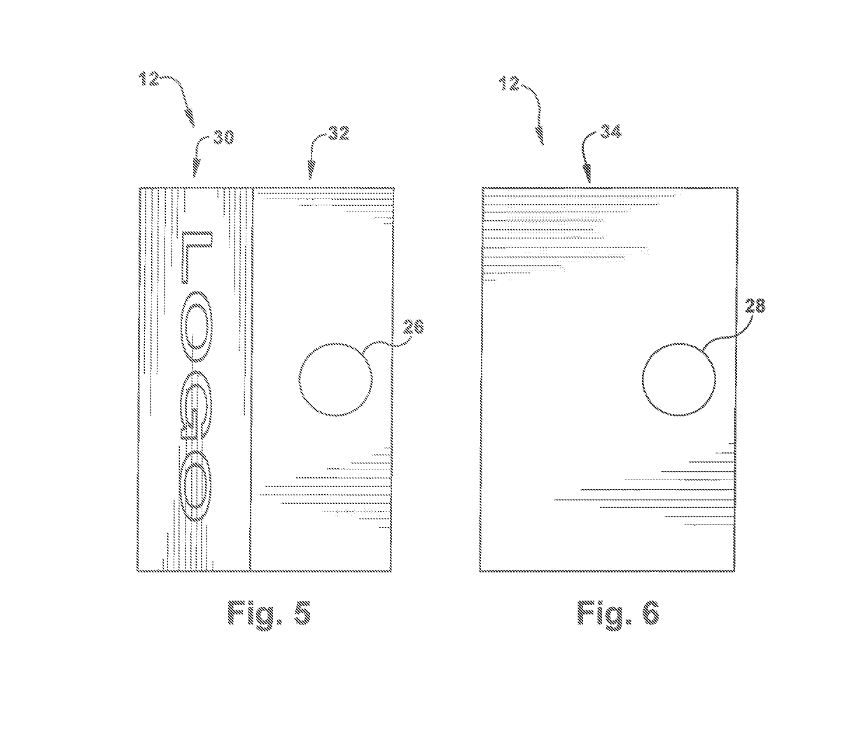

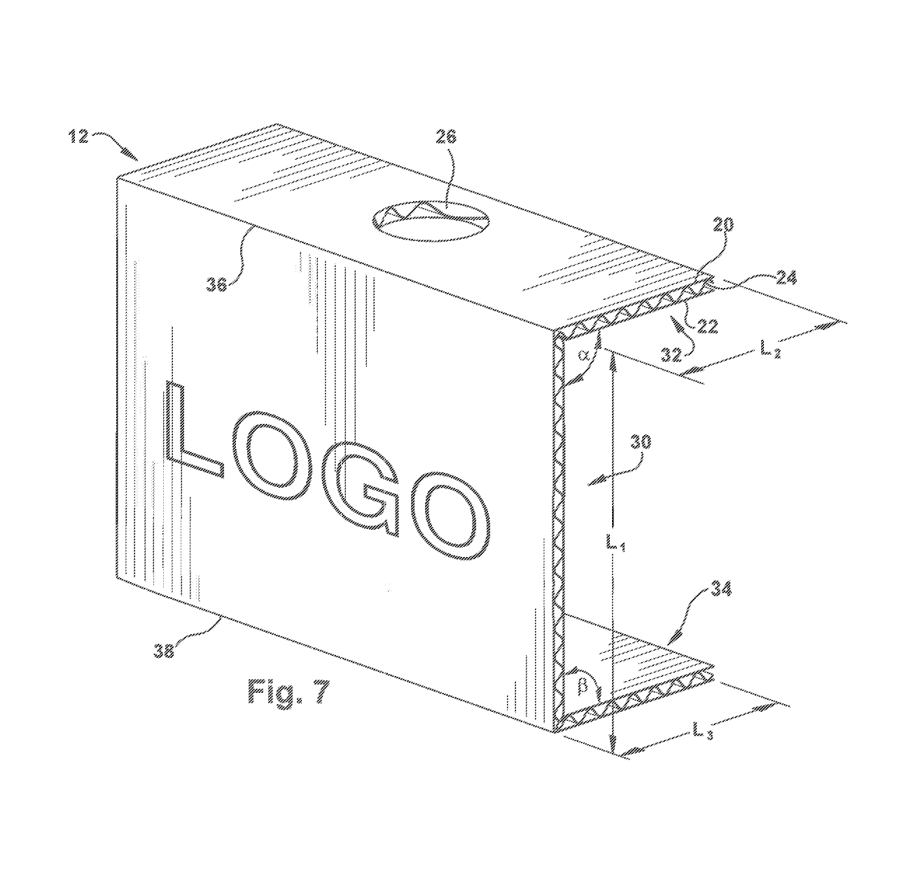

FIG. 5 and FIG. 6, respectively, show top and bottom views of portable sign 12 in the folded position, in accordance with an example of the present invention. FIG. 7 illustrates another example of portable sign 12 which has an inner wall 24 in the form of a corrugated layer having ridges and valleys between front wall 20 and rear wall 22. The series of parallel ridges and valleys or furrows create a plurality of inner wall portions that extend from front wall 20 to rear wall 22. Portable sign 12 is thereby strengthened and holds its shape at least in part because the front and rear walls 20, 22 are reinforced by the corrugated inner walls 24.

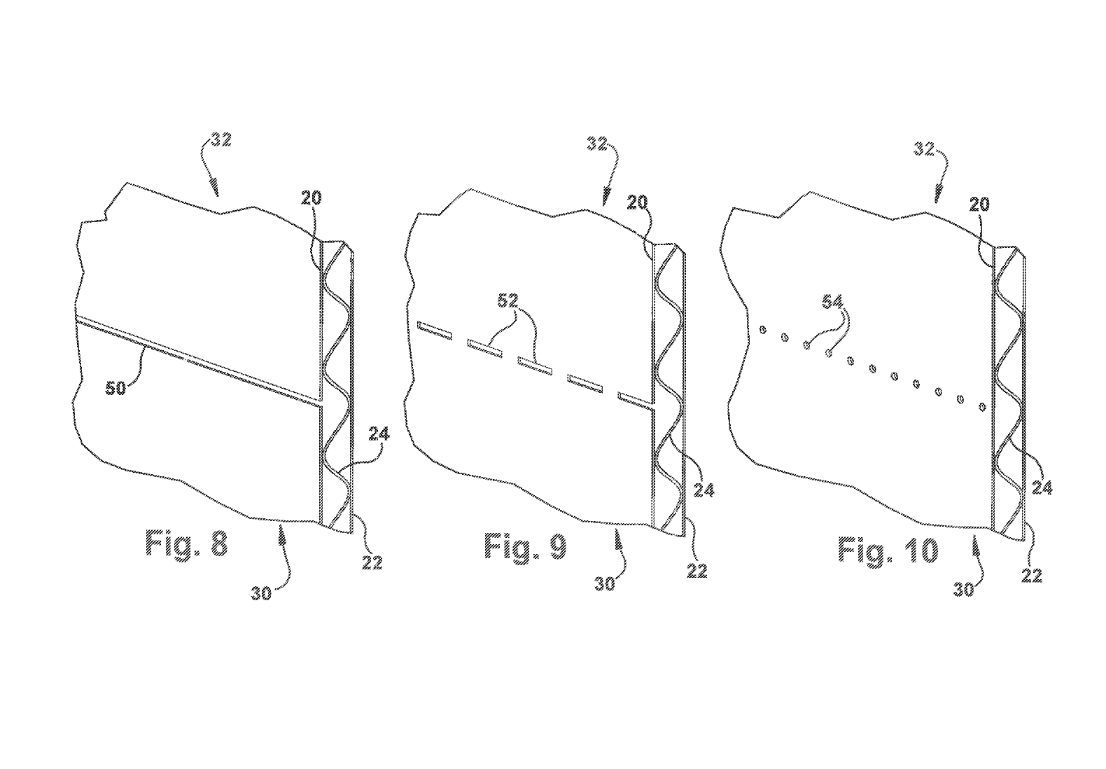

FIGS. 8-10 show various examples of optional pressure scores and cut scores of portable sign 12. FIG. 8 shows an example of a slice cut 50, FIG. 9 shows an example of perforated die cut 52, and FIG. 10 shows an example of pressure score 54 of front wall 20. Pressure scores and die cuts 50, 52, 54 can augment or replace the bends 36, 38 and can be made on either front wall 20 or rear wall 22 or both. These cuts, perforations, and indentations can be made between the plurality of inner walls 24 and facilitate easy bending of the portable sign 12 while maintaining integrity and strength in the portable sign.

A portable sign assembly in accordance with the present invention, for example sign assembly 10 (FIG. 1) includes but is not limited to, any examples of portable sign 12 described above, and a pole 14 for mounting the portable sign. A sign assembly herein includes a portable sign that is a unitary structure having a front wall, a rear wall and a plurality of inner walls disposed between the front wall and rear wall. Pole 14 can be made of several materials, including but not limited to, metal, polymer, paper, cardboard, and combinations thereof. Poles 14 can be several shapes and sizes and non-uniform in cross-section.

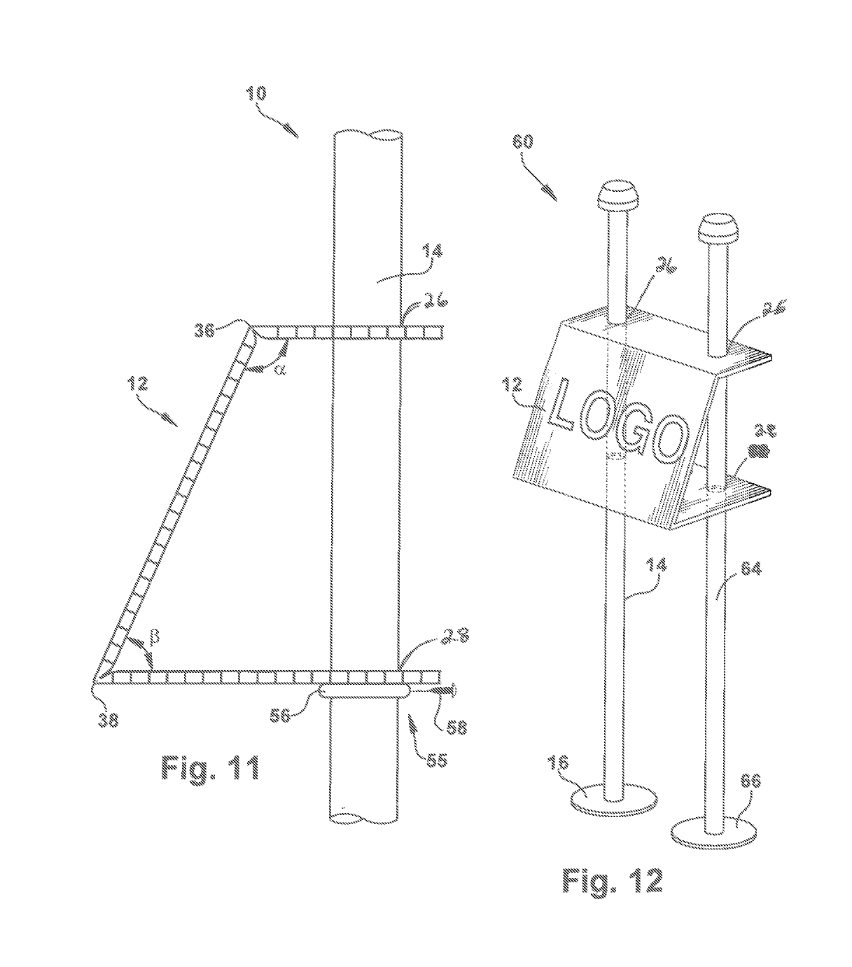

Referring to FIG. 11 which illustrates a side view of sign system 10, includes an additional feature to prevent portable sign 12 from sliding down pole 14 due to gravity, wind, or other external forces. Pole 14 of sign system 10 can further include a protrusion or shoulder 55 that increases the outer diameter, Dₚ, of pole 14. For example, pole 14 can include an integrated feature of the pole, such as for example, a lever that creates a stop against sign 12. Protrusion 55 can also be created by the addition of a device 56 or a combination of devices 56 and 58, which can be added to pole 14. Examples of a device(s) 56, 58, include but are not limited to, gasket, o-ring, tape, nail, screw, etc.

FIG. 12 illustrates an alternative sign system 60, which includes at least two poles 14, 64. Sign 12 a pair of openings 26 in the top portion 32 and a pair of openings 28 in the bottom portion 34 to accommodate poles 14 and 64, respectively. The pole 64 can optionally include pole stand 66. The double-pole 14, 64, configuration as shown is especially advantageous for larger signage. In this configuration, two or more pole stands 16, 66 will better stabilize large signs both in indoor and outdoor use. Any of the example sign systems described above can include a plurality of poles for support, and optionally, a plurality of pole stands.

In another example of the present invention, a portable sign kit includes a portable sign that is a unitary structure having a front wall, a rear wall and a plurality of inner walls disposed between the front wall and rear wall. The kit also includes a pole for mounting the portable sign. In one example the portable sign kit can be a “do-it-yourself” sign kit that is planar and free from openings, cuts, pressure scores, slices or perforations. For example, a portable sign can be provided that does not include any openings for a pole, and does not include folds, pressure scores or cut scores. In another example, the kit includes a portable sign with pre-cut openings for the pole, and in another example the portable sign includes at least one of pressure scores and cut scores on a front and/or rear wall. In another example, sign assembly kit includes but is not limited to any of the examples of portable sign 12 and pole 14 described above. The kit can include a plurality of portable signs, or a plurality of poles, or both a plurality of portable signs and a plurality of poles.

A method for making a sign assembly includes folding a portable sign that is a unitary structure comprising a front wall, a rear wall and a plurality of inner walls disposed between the front wall and the rear wall; and mounting the portable sign onto a pole such that the pole extends through the first end portion and second end portion of the portable sign. In another example the method of making a sign assembly further includes cutting an opening in the first end portion and cutting an opening in the second end portion of the portable sign prior to mounting the portable sign onto the pole. In another example, the method includes at least one of pressure scoring and slicing the portable sign prior to folding the portable sign. Pressure scoring and die cutting can be performed use a die to fixture the portable sign. For example, a die cutting machine can be used as these machines shear low-strength materials such as portable signs described herein that is made of paperboard, fiberboard, polymer, foam and metal sheet.

While the present invention has been illustrated by the description of embodiments thereof, and while the embodiments have been described it is not the intention of the applicant to restrict or in any way limit the scope of the appended claims to the details herein. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept and which are intended to be encompassed by the following claims.

What is claimed is:

1. A portable sign for a pole, comprising:
a central portion;
a first end portion extending from the central portion at a first angle relative to the central portion;
a second end portion extending from the central portion at a second angle relative to the central portion;
wherein the portable sign is a unitary structure and each of the central portion, first end portion and second end portion comprises a front wall, a rear wall and an inner wall disposed between the front wall and the rear wall.

2. The portable sign of claim 1, wherein the first end portion has an opening and the second end portion has an opening, each opening being configured to form a friction fit with the pole to prevent relative movement between the portable sign and pole.

3. The portable sign of claim 1, wherein the first end portion has a first opening and the second end portion has a second opening, and the first end portion is substantially parallel to the second end portion and the first opening and second opening are aligned.

4. The portable sign of claim 1, wherein the inner wall of the portable sign extends from the front wall to the rear wall.

5. The portable sign of claim 1, wherein the inner wall is shaped as a corrugated layer between the front wall and rear wall.

6. The portable sign of claim 1, wherein the inner wall extends substantially perpendicular to the front wall and rear wall.

7. The portable sign of claim 1, wherein at least two substantially parallel inner walls extend from the front wall to the rear wall.

8. The portable sign of claim 1, wherein:
a first fold is provided between the first end portion and the central portion and a second fold is provided between the second end portion and the central portion, wherein the first and second folds provide a resilience to the portable sign that helps hold the portable sign on the pole; and
the first end portion has a first opening located a first distance from the first fold, and the second end portion has a second opening located a second distance from the second fold.

9. The portable sign of claim 8, wherein the first distance is equal to the second distance.

10. The portable sign of claim 8, wherein the first distance is unequal to the second distance.

11. The portable sign of claim 8, wherein at least one of a pressure score or a cut score is present along the first fold and the second fold.

12. The portable sign of claim 11, wherein the at least one of a pressure score and a cut score is present on at least one of the front wall and rear wall.

13. The portable sign of claim 1, wherein the first angle is substantially equal to the second angle.

14. The portable sign of claim 1, wherein the first angle and the second angle are unequal.

15. The portable sign of claim 1, wherein the first angle is greater than the second angle and a display surface of the central portion faces upward.

16. A sign assembly comprising:
a portable sign comprising a front wall, a rear wall and an inner wall disposed between the front wall and the rear wall;
wherein the portable sign is a unitary structure comprising a central portion, a first end portion extending from the central portion at a first angle relative to the central portion and a second end portion extending from the central portion at a second angle relative to the central portion; and
a pole that extends through an opening of the first end portion and an opening of the second end portion of the portable sign.

17. The sign assembly of claim 16, wherein the diameter of the opening in the first end portion of the portable sign and the diameter of the opening in the second end portion of the portable sign is less than the outer diameter of the pole to form a friction fit between the openings and pole to prevent relative movement between the portable sign and the pole.

18. The sign assembly of claim 16, wherein the diameter of the opening in the first end of the portable sign and the diameter of the opening in the second end portion of the portable sign are within about 95% to about 100% of the outer diameter of the pole.

19. The sign assembly of claim 16, wherein:
a first fold is provided between the first end portion and the central portion and a second fold is provided between the second end portion and the central portion; and
the first and second folds are parallel to the plurality of inner walls disposed between the front wall and the rear wall.

20. The sign assembly of claim 18, wherein the first angle and second angle are unequal and the central portion is oriented at an angle relative to the pole.

21. A portable sign kit comprising:
a portable sign that is a unitary structure comprising a front wall, a rear wall and a plurality of inner walls disposed between the front wall and the rear wall; and
a pole for mounting the portable sign.

22. A method of manufacturing a sign assembly, the method comprising:
folding a portable sign that is a unitary structure comprising a front wall, a rear wall and a plurality of inner walls disposed between the front wall and the rear wall;
mounting the portable sign onto a pole such that the pole extends through the first end portion and second end portion of the portable sign.
